(19) United States
(12) Patent Application Publication
(10) Pub. No.: US 2020/0260745 A1
(43) Pub. Date: Aug. 20, 2020

(54) MULTI-NOZZLE APPARATUS FOR INJECTING FLAVORED SAUCE INTO FOOD PATTIES

(71) Applicants: Gardner Lawton Hall, Holderness, NH (US); April Potter Vachon, Holderness, NH (US)

(72) Inventors: Gardner Lawton Hall, Holderness, NH (US); April Potter Vachon, Holderness, NH (US)

(21) Appl. No.: 16/793,568

(22) Filed: Feb. 18, 2020

Related U.S. Application Data
(60) Provisional application No. 62/807,108, filed on Feb. 18, 2019.
(60) Provisional application No. 62/807,425, filed on Feb. 19, 2019.

(51) Int. Cl. A22C 17/00; A23L 13/70; A47J 43/16

(52) U.S. Cl. CPC A22C 17/0053; A23V 2002/00; A47J 43/16; A23L 13/72

(57) ABSTRACT

A multi-nozzle injector head adapted to infuse liquid food products into soft food products is provided. A distal end of the multi-nozzle injector head provides an operative surface dimensioned to be generally coextensive with an upper half of the soft food product in patty form. The operative surface provides a plurality of nozzles that penetrate the upper half for approximately half the depth of the patty. The proximal end of the injector head fluidly interconnects a reservoir chamber and the plurality of nozzles. The liquid food product is housed in the reservoir chamber and urged toward the distal end thereof by way of a plunger based delivery system.

### CROSS-REFERENCE TO RELATED APPLICATION

This application claims the benefit of priority of U.S. provisional application No. 62/807,108, filed 18 Feb. 2019, and the benefit of priority of U.S. provisional application No. 62/807,425, filed 19 Feb. 2019, the contents of which are herein incorporated by reference.

### BACKGROUND OF THE INVENTION

The present invention relates to the culinary arts and, more particularly, to a multi-nozzle apparatus adapted for injecting liquids into food products in a speedier and simpler method than the prior art; specifically, injecting flavored sauce into meat and vegetable patties for making burgers.

Traditionally burgers are cooked and then flavored topically with sauces, condiments, and the like. This produces a drier, less tasty burger. Single nozzle injection and hand infusion applicators of sauces are slow and do not perform as well in a restaurant setting, especially a fast food one where hundreds of burgers are made every day. The current devices also present a greater risk of contamination through requiring the user to handle the applicable patty.

As can be seen, there is a need for a multi-nozzle apparatus adapted for injecting liquids into food products in a speedier and simpler method than the prior art; specifically, injecting flavored sauce into meat and vegetable patties for making burgers. The multi-nozzle injector of the present invention also requires less handling of the burger patty, thus improving quality, taste, and consistency through infusing flavor and moisture into an uncooked burger patty, while reducing the potential contamination.

### SUMMARY OF THE INVENTION

In one aspect of the present invention, a multi-nozzle injector head adapted to infuse liquid food products into absorbent food products includes the following: a proximal end; a distal end terminating in an operative surface; and a plurality of nozzles fluidly coupled to the proximal end, wherein the plurality of nozzles comprise between twenty-four and forty-eight nozzles, and wherein each nozzle has a same length.

In another aspect of the present invention, liquid food product injection delivery system includes the following: the above-mentioned multi-nozzle injector head adapted to infuse liquid food products into absorbent food products; a reservoir chamber extending from a first end to a second end; the first end fluidly coupled to the proximal end; a plunger tip dimensioned to tightly fit an inner surface of the reservoir chamber; and a delivery system connected to the second end and operatively associated with the plunger tip for selectively urging the plunger tip toward the first end.

In yet another aspect of the present invention, a method for infusing a burger patty with a flavored sauce includes the following: providing the liquid food product injection delivery system disclosed above; dimensioning the operative surface to be generally coextensive with an upper surface of the burger patty; dimensioning the same length to be half a depth of the burger patty; filling the reservoir chamber with the flavored sauce; injecting the plurality of nozzles through the said upper surface until said upper surface abuts the operative surface; and selectively urging the plunger tip toward the first end.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is an exploded perspective view of an exemplary embodiment of the present invention;

FIG. 3 is a front elevation view of an exemplary embodiment of the present invention;

FIG. 4 is a bottom perspective view of an exemplary embodiment of an injector head of the present invention;

FIG. 5 is a bottom elevation view of an exemplary embodiment of the injector head of the present invention;

FIG. 6 is a section view of an exemplary embodiment of the present invention, taken along line 6-6 of FIG. 1, illustrating the present invention in use prior to deploying a trigger assembly;

FIG. 7 is a section view of an exemplary embodiment of the present invention, also taken along line 6-6 of FIG. 1, illustrating the flavor being injected through deployment of the trigger assembly; and

FIG. 8 is an enlarged detail section view of an exemplary embodiment of the injector head of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a multi-nozzle injector head adapted to infuse liquid food products into soft food products. A distal end of the multi-nozzle injector head provides an operative surface dimensioned to be generally coextensive with an upper half of the soft food product in patty form. The operative surface provides a plurality of nozzles that penetrate the upper half for approximately half the depth of the patty. The proximal end of the injector head fluidly interconnects a reservoir chamber and the plurality of nozzles. The liquid food product is housed in the reservoir chamber and urged toward the distal end thereof by way of a plunger based delivery system.

It should be understood by those skilled in the art that the use of directional terms such as upper, lower, upward, downwardly, top, left, right and the like are used in relation to the illustrative embodiments as they are depicted in the figures, the upward direction (or upper) being toward the top of the corresponding figures, downward direction being toward the bottom of the corresponding figures.

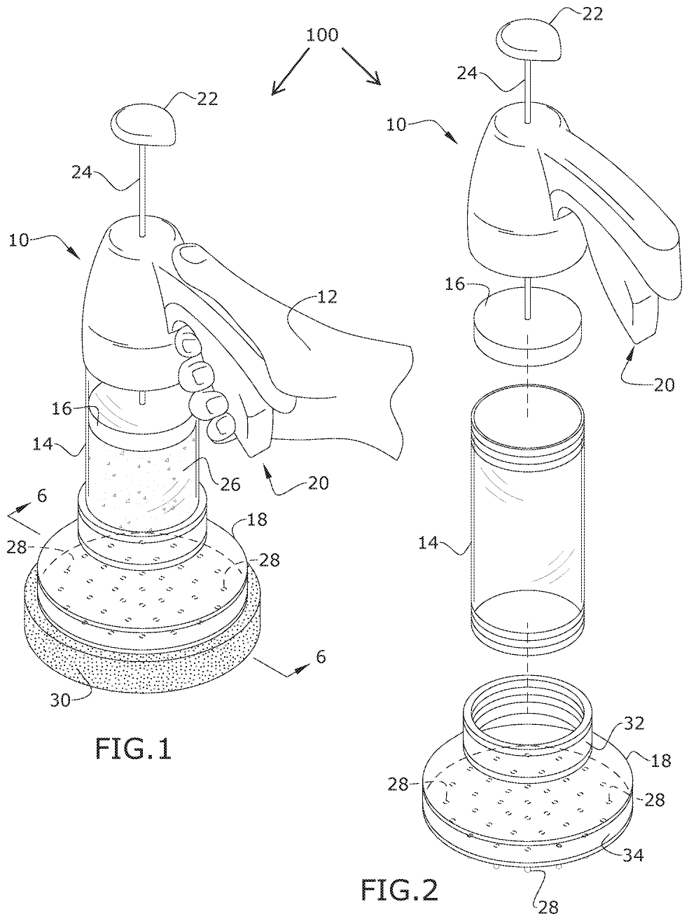

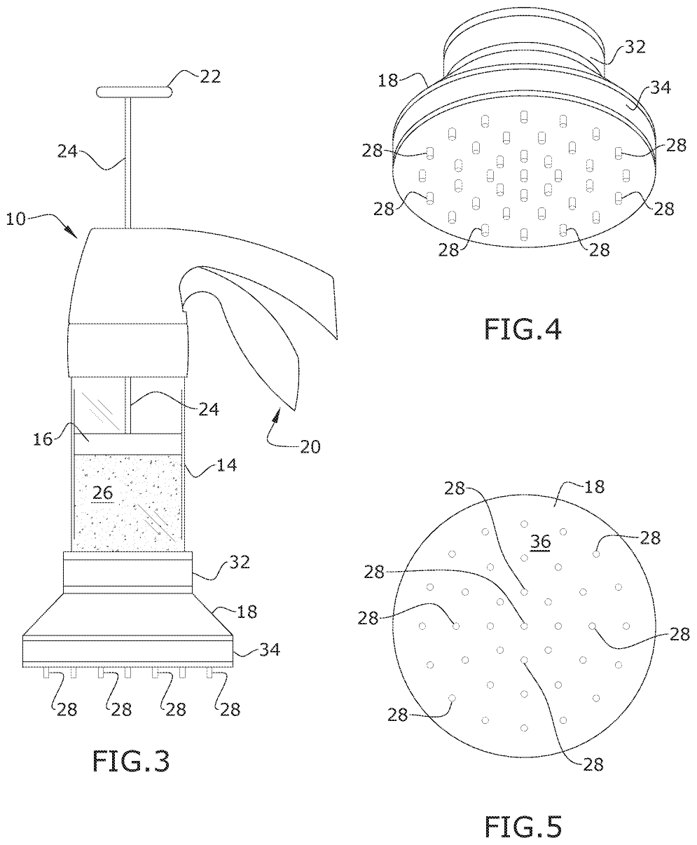

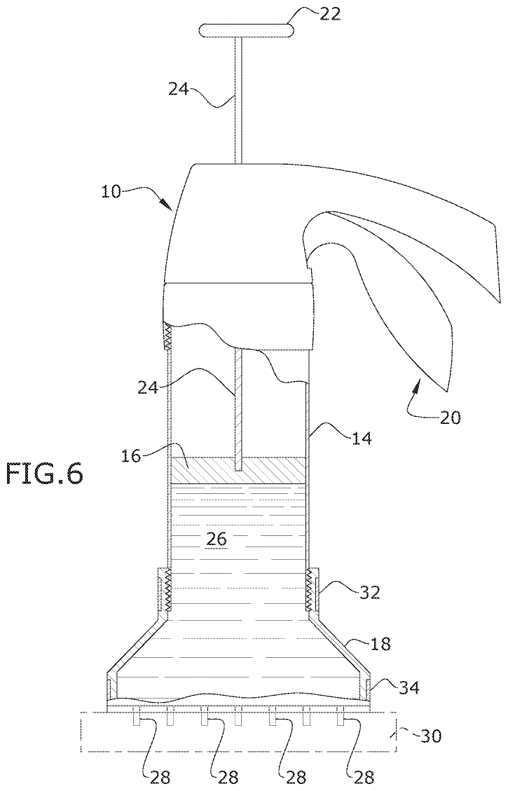

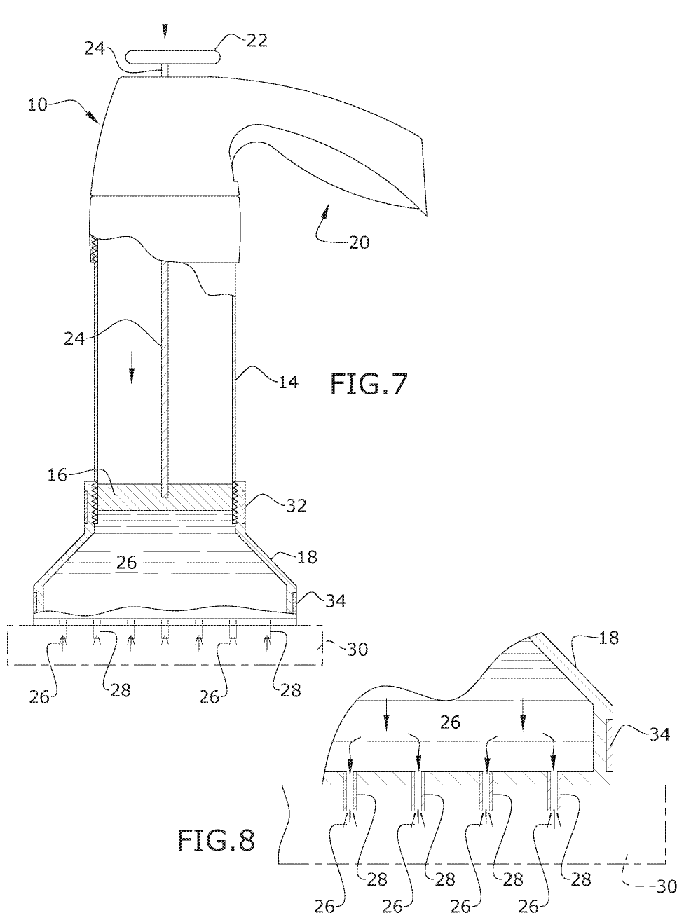

Referring to FIGS. 1 through 8, the present invention may include a fluid injection delivery system 100 providing a multi-nozzle injector head 18 fluidly coupled to a first end of a reservoir chamber 14, wherein the opposing second end of the reservoir chamber 14 is operatively associated with a delivery system 10 for urging a fluid 26 toward the first end. The fluid 26 may be flavored sauce or other liquid food product.

The delivery system 10 may be a plunger assembly using a ratcheted or screw advanced plunger tip 16, air or electric impulse element. The plunger tip 16 and reservoir chamber 14 may be dimensioned and adapted so that the plunger tip 16 fits tightly within the cylindrical reservoir chamber 14. The plunger tip 16 can be linearly pulled or pushed along the inside of the reservoir chamber 14, allowing the injection delivery system 100 to selectively expel the fluid 26 through the plurality of orifices or nozzles 28 of the injector head 18.

In certain embodiments, the plunger tip 16 may be connect to a plunger cap 22 by way of a plunger rod 24 so that by urging the plunger cap 22 in a direction parallel with the plunger rod 24 moves the plunger tip 16 in concert. Additionally, the plunger rod 24 may be operatively associated with a trigger assembly 20 so that when the trigger assembly 20 is engaged, the plunger tip 16 is urged through the reservoir chamber 14.

The injector head 18 extends between a distal end and a proximal end 32 dimensioned and adapted to fluidly connect to the reservoir chamber 14. The distal end 34 terminates at an operative surface 36 that is dimensioned to be generally coextensive with a standardly sized burger patty 30, or four to five inches in diameter. The operative surface 36 provides a plurality of nozzles 28 fluidly connected to the reservoir chamber 14. Each nozzle 28 protrudes from the operative surface 36 between one-quarter to a half an inch. The plurality of nozzles 28 may number between twenty-four and forty-eight in total and be dimensioned and adapted to penetrate the upper surface of the burger to roughly half its depth. The injector head 18 could be disposable, one use packet filled with one application of flavored sauce/fluid 26 that could be injected by a press.

A method of using the present invention may include the following. The injection delivery system 100 disclosed above may be provided. The multi-nozzle injector head 18 fits exactly on a burger patty 30 with the plurality of nozzles 28, penetrating the burger patty 30 surface over its entirety. The reservoir chamber 14 is filled with sauce, other liquid food product, or fluid 26 and fluidly coupled to the injector head 18. The delivery system 10 of plunger and ratchet or other pump/piston embodiment having a plunger tip 16 is attached to the reservoir chamber 14 and deployed by a user 12 so as to urge the fluid 26 through the reservoir chamber 14, the injector head 18 and into the burger patty 30. The patty 30 could be infused with flavored sauce, and ready to be cooked on a grill without flipping it.

Additionally, the present invention could be part of an automated process, wherein the injection delivery system 100 is operated by robots. Other soft food could be infused with flavored sauce through the injection delivery system 100. The present invention may produce flavor sauce-infused burgers made of any meat or vegetable.

It should be understood, of course, that the foregoing relates to exemplary embodiments of the invention and that modifications may be made without departing from the spirit and scope of the invention as set forth in the following claims.

What is claimed is:

1. A multi-nozzle injector head adapted to infuse liquid food products into absorbent food products, comprises:
a proximal end;
a distal end terminating in an operative surface; and
a plurality of nozzles fluidly coupled to the proximal end.

2. The multi-nozzle injector head adapted to infuse liquid food products into absorbent food products of claim 1, wherein the plurality of nozzles comprise between twenty-four and forty-eight nozzles.

3. The multi-nozzle injector head adapted to infuse liquid food products into absorbent food products of claim 2, wherein each nozzle has a same length.

4. The multi-nozzle injector head adapted to infuse liquid food products into absorbent food products of claim 1, wherein the same length ranges between one-quarter to a half of an inch.

5. A liquid food product injection delivery system, comprising:
the multi-nozzle injector head adapted to infuse liquid food products into absorbent food products of claim 3;
a reservoir chamber extending from a first end to a second end;
the first end fluidly coupled to the proximal end;
a plunger tip dimensioned to tightly fit an inner surface of the reservoir chamber; and
a delivery system connected to the second end and operatively associated with the plunger tip for selectively urging the plunger tip toward the first end.

6. A method for infusing a burger patty with a flavored sauce, comprising:
providing the liquid food product injection delivery system of claim 5;
dimensioning the operative surface to be generally coextensive with an upper surface of the burger patty;
dimensioning the same length to be half a depth of the burger patty;
filling the reservoir chamber with the flavored sauce;
injecting the plurality of nozzles through the said upper surface until said upper surface abuts the operative surface; and
selectively urging the plunger tip toward the first end.
